(19) United States
(12) Patent Application Publication
(10) Pub. No.: US 2004/0091649 A1
(43) Pub. Date: May 13, 2004

(54) Extrusion blow molding method

(76) Inventors: Kurt H. Ruppman SR., Allen, TX (US); Kurt H. Ruppman JR., Allen, TX (US); Kraig A. Ruppman, Frisco, TX (US)

Correspondence Address: THE LAW OFFICES OF H. DENNIS KELLY, 2401 TURTLE CREEK, DALLAS, TX, 75219, US

(21) Appl. No.: 10/065,672

(22) Filed: Nov. 7, 2002

(51) Int. Cl. B29C 49/04; B65D 1/00

(52) U.S. Cl. 428/35.7; 264/540

(57) ABSTRACT

Commercially available plastic resin that has been stored in ambient air is contacted with an oxygen-depleted atmosphere to reduce the absorbed oxygen level in the resin, then extrusion molded into the desired shape. The resin can be initially blown against the mold using air, but preferably is blown using an inert gas at or near ambient temperature. Immediately following the blowing step, the inert gas is use to pressurize and flush the molded resin, followed by depressuring the molded product and releasing it from the mold. A second embodiment employs molds kept at a temperature between about 50° F. and 150° F., and the inert gas used to pressurize and flush the molded resin is at a temperature below about 0° F.

### TECHNICAL FIELD

This invention relates in general to extrusion blow molding processes. In particular, the invention relates to an improved method using an inert gas that produces containers having reduced levels of absorbed oxygen and less size variation from container to container.

### BACKGROUND OF THE INVENTION

Raw polymer resin absorbs oxygen from the atmosphere during storage. The need for reducing absorbed oxygen in resins consisting predominantly of PET polymers has been addressed in another patent because of the tendency for PET to form acetaldehyde during thermal breakdown. However, it has since been discovered that reducing oxygen content in other polymer types also has significant performance benefits.

Extrusion blow molding is a widely used method for making plastic containers. For example, most plastic milk bottles are presently made by extrusion blow molding of high-density polyethylene (HDPE). Oxygen loosely bound to the polymer can react with the container contents, creating undesirable byproducts. This is especially true in the food and beverage industries, where oxygen promotes bacterial growth, causes breakdown of vitamins, and helps form oxalic acids and other compounds that ruin taste. In addition, present manufacturing methods produce bottles that vary significantly in size after complete cooling, requiring that bottles be blown to a larger than desired design size in order to ensure that no bottles will hold less product than its labeled size. Annealing the containers in ovens is used to set container size, but this adds further expense and time to manufacture of each container.

### SUMMARY OF INVENTION

In general, a method having the desired features and advantages is achieved using an inert gas throughout the process to help remove absorbed oxygen and prevent reabsorption of oxygen. The method can be practiced using substantially conventional drying and extrusion molding apparatus. The changes from conventional apparatus mainly comprise adding a small gas line connected near the outlet base of the drying hopper (when a drying step is present) or the loading hopper in the extrusion molding equipment and the use of a novel extrusion blow pin that allows two different gasses to be used to blow the plastic. The gas line near the drying hopper outlet base supplies a steady flow of inert gas up into the drying hopper and into the lines between the drying hopper and the extrusion blowing equipment. The injection of the inert gas results in an oxygen-depleted atmosphere in the drying hopper, and substantially displaces oxygen from equipment downstream of the drying hopper. The drying procedure is otherwise conventional, although slightly higher drying temperatures can be used, as the reduced oxygen content in the drying hopper tends to reduce the formation of undesirable products in the resin. After the drying step, the resin is sent to the extrusion molding equipment where it is heated to an appropriate temperature and extruded into a mold. The extruded material is initially blown against the mold walls using air, followed by a pressuring/flushing step using an inert gas. Preferably, the inert gas is also used for the initial blowing step. Conventional molds (temperatures at or below ambient) can be used. In a preferred alternate embodiment, the mold walls are heated to a temperature between about 50° F. to about 150° F. and the pressuring/flushing gas has a temperature below about 0° F.

Nitrogen gas is preferred as the inert gas, but any dry gas that displaces oxygen and does not react adversely with the polymers can be used. The inert gas should not contain significant quantities of impurities that would also react adversely. Some suitable gases include carbon dioxide (but not the typical commercial grades that contain water vapor or other undesirable impurities), argon, and chlorofluorocarbons.

The present invention is well adapted for molding of a wide range of polymers. Polycarbonate, polyvinyl chloride, polyethylene, polypropylene, polystyrene, and PETG polymers and their derivatives can be molded using the method of the invention. Polymer blends or copolymers of the basic polymers and their derivative polymers should also be usable.

The method of the invention requires minimal additional equipment which can be retrofitted on existing extrusion blowing equipment, thereby minimizing capital costs. Since the method of the invention is predominantly the same as methods presently in use for drying and extrusion blow molding, almost no additional training is required for a person of ordinary skill in the art to practice the method of the invention. It produces containers of consistent size without the need for post-blowing annealing in ovens, which is required using conventional methods. Finally, when cold inert gas is used for pressuring/flushing, the bottles produced are inherently sterilized, and do not require additional sterilization before being filled with beverages such as milk that are sensitive to microbial attack.

Additional features and advantages of the invention will become apparent in the following detailed description and in the drawings.

### BRIEF DESCRIPTION OF DRAWINGS

FIG. 1 is a schematic front plan view of a preferred apparatus for practicing the method of the invention.

FIG. 2 is a cross-sectional front plan view of a novel blow pin used in the extrusion blow molding method.

### DETAILED DESCRIPTION

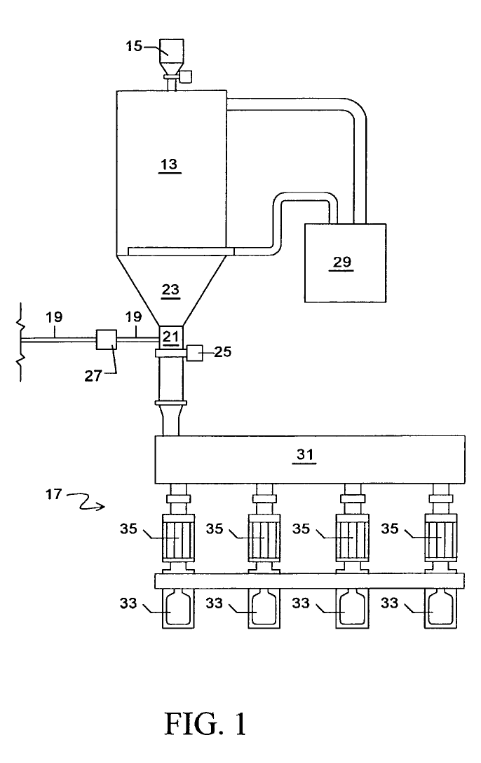

FIG. 1 shows a preferred apparatus in schematic form only without intending to describe any detailed dimensions or configuration. The apparatus is used to carry out the method of the invention for plastic resins that require drying prior to extrusion molding, such as polycarbonates, nylon, and PETG. The apparatus 11 includes a drying hopper 13 connected to extrusion molding equipment 17 including a loading hopper 31. The equipment is conventional with two general exceptions: a gas line 19 is fitted to the short stand pipe section 21 located between the bottom of the drying hopper feed cone 23 and the outlet shutoff valve 25. A pressure regulator 27 regulates the supply of nitrogen gas and provides the means for injecting the nitrogen into the drying hopper 13. A manual or automatic flow control loop can be used in place of the pressure regulator 25, as well as other means known in the art for injecting a gas into a process.

Prior to the first step, the drying hopper 13 is loaded with resin. Typically, an initial inventory is loaded into the drying hopper 13, and a minimum inventory is then maintained in the drying hopper 13 using a control system (not shown) based on resin level or weight. To maintain inventory in the drying hopper 13, a small loading hopper 15 is located above the drying hopper 13 and filled periodically from a remote resin silo (not shown). When the loading hopper 15 is filled, the inlet to the hopper is closed and the loading hopper dumps its inventory into the drying hopper 13. Each time the loading hopper 15 dumps, the ambient atmosphere trapped in the loading hopper 15 mixes with the atmosphere in the drying hopper 13. Otherwise, the drying hopper 13 with its associated equipment operates as a pseudo-closed system, so the average flow rate of nitrogen through the gas line 19 is relatively small. Normally, oxygen is not completely flushed from the drying hopper 13, although this is preferred if the added nitrogen consumption can be allowed. An oxygen-depleted atmosphere is maintained in the drying hopper 13 throughout the drying step. With regards to this invention, the term “oxygen-depleted atmosphere” is defined as an atmosphere containing less than about 17.5 volume percent oxygen, and preferably less than about 10 volume percent oxygen.

The residence time for resin in the drying hopper ranges from about 3 hours to about 5 hours, depending on the drying temperature used and the type of polymer used. Dehumidifying equipment 29 dehumidifies and heats the circulating atmosphere. Drying time and temperature are set in accordance with standard practice in the industry. As an example, drying temperatures for PETG range from about 120° C. to about 170° C., with higher temperatures generally corresponding to shorter residence times. Improvement in absorbed oxygen levels will likely occur even without the use of heating, but heating is preferred not only to accelerate the release of absorbed oxygen, but also to remove absorbed water.

Drying takes place in an oxygen-depleted atmosphere to help release any oxygen that may be loosely bound to the surface of the PET resin, or trapped in bubbles in the resin. Obviously, the lower the percentage of oxygen in the oxygen-depleted atmosphere, the better. A rough indication of how much oxygen is present in the polymer is given by the oxygen release test set out in test procedure ASTM 1945.

An alternative apparatus embodiment is envisioned in which the drying hopper 13 is systematically purged of most or all of the oxygen in the gas inside the drying hopper 13. This purging can occur in a batch or continuous fashion, or be performed as needed via a manual or automatic control loop to maintain a desired oxygen concentration in the drying hopper 13. Purging can be achieved by employing a vent located distal to the gas line connection at a point on the drying hopper 13 or its associated drying equipment that will ensure effective purging of the gas in the system. This embodiment can theoretically lower the oxygen level in the drying hopper down to zero, but requires more extensive modifications to existing equipment, and consumes more of the inert gas.

When drying is not required (such as for polyvinyl chloride, polyethylene, polypropylene, and polystyrene) the gas line 19 and its associated equipment are then connected to the loading hopper 31 that is part of the extrusion blow molding equipment 17. In all cases, the objective is to expose the resin to the oxygen-depleted atmosphere for a sufficient time (at least 15 minutes for resins not requiring drying) to remove a significant amount of absorbed oxygen from the plastic resin. The same guidelines should therefore be followed, such as keeping the oxygen level in the atmosphere contacting the resin at or below the oxygen-depleted level all the way through the equipment up to extrusion into the mold 33. An oxygen-depleted atmosphere is not required within the mold 33, as this would require extensive and costly equipment modification that is not required for reasons that will be discussed below.

Following the drying step, the plastic resin is transferred to the extrusion molding equipment 17. First, heating elements (not shown) are turned on, thereby raising the temperature of the plastic resin above the glass transition point, so that it will flow sufficiently well to permit it to be extruded. With each extrusion cycle, an amount of gas is believed to travel into the extrusion molding equipment along with the resin. It is believed that this gas, following the initial molding testing cycles, is almost completely comprised of the purge gas from the gas line 19 (this will be especially true for gases such as carbon dioxide which are heavier-than-air and will stratify easily, thereby ensuring that air/oxygen is displaced from piping below the injection point). The plastic resin therefore contacts an atmosphere somewhere between an oxygen-depleted atmosphere and an atmosphere substantially devoid of oxygen. As a practical guideline, “substantially devoid of oxygen” is defined as containing less than about one volume percent oxygen.

The next few steps of the method of the invention follow conventional extrusion blow molding processes. First, a predetermined quantity of plastic resin is extruded between the opened halves of a mold, and the mold halves are closed. In the next step, the resin is blown against the mold walls. Immediately following the blowing step, the inert gas is blown into the molded resin both to pressurize the molded resin and hold it against the mold walls, and to flush the interior of the molded resin as it cools and forms the finished product. While the pressuring/flushing gas can be at or near ambient temperature, preferably the gas is at a temperature below at least about 0° F., and preferably below about −100° F.

The flushing action has several advantages. First, it reduces the time required for the resin to cool, thereby reducing total production cycle time. This is especially useful for polyethylene polymers, which have higher heat capacity than other polymers such as PET and normally require more time to cool. Conventional cooling time takes up about sixty percent of total production cycle time for polyethylene. Pilot plants have reduced cooling time by about thirty percent. Flushing also reduces the crystallization of the plastic in the interior of the container, which is generally considered desirable to prevent stress cracking of the container during use. Finally, flushing also removes any oxygen introduced during the extrusion and blowing steps. The total time the resin is exposed to oxygen during these steps is small enough to prevent any significant reabsorption of oxygen into the resin, so no special steps need be taken to prevent oxygen from contacting the resin during those steps. As previously discussed, flushing with cold (below 0° F.) inert gas also sterilizes the molded container during manufacture. It is believed that the use of ambient inert gas will also have this advantage.

Conventional extrusion blow molds are kept at a temperature at or below 50 degrees Fahrenheit to achieve acceptable cooling times. A second embodiment of the method is envisioned, wherein the mold is heated to a temperature between about 50 and 150 degrees Fahrenheit, and the pressuring/flushing gas has a temperature below at least about 0° F. and preferably below about −100° F. The increased cooling rate achieved using cold gas allows faster production cycles as previously discussed. It also creates a bottle with a novel structure for extrusion blow molded containers. The finished product has a relatively low percentage of crystalline polymer at the inside surface of the container, and relatively higher crystallinity on the outside surface, due to contact with the heated mold walls. This region of higher crystalline polymer acts like a tough “skin” that significantly improves the dimensional stability of the container, resulting in better control of container size. Barrier properties have been shown to be improved for PET resins, and should also be improved for other polymers as well.

The gas used to blow the resin against the mold can be air, as it does not contact the plastic long enough to cause measurable oxygen absorption by the plastic, as previously discussed. However, the inert gas can be used for the molding step if desired. When the inert gas is used for blowing, it should be supplied at or near ambient temperatures in all embodiments, rather than at the colder temperatures used for the pressuring/flushing gas in the second embodiment.

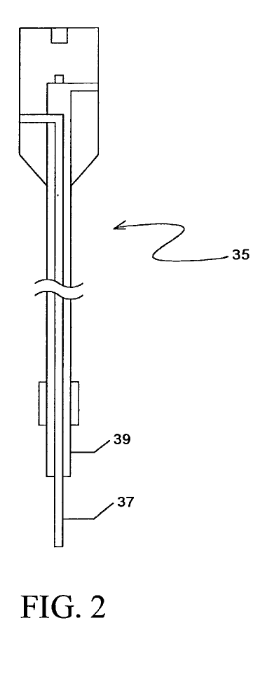

FIG. 2 shows a novel blow pin 35 used to practice the method of the invention. The figure is schematic only without intending to describe any detailed dimensions or configuration. A inner blow rod 37 supplies the inert gas used for pressuring/flushing the molded resin, while an outer tube 39 supplies the gas used for the initial blowing of the resin against the mold walls.

The invention has several advantages over the prior art. The method produces containers having less variation in size, and can make them in less time, increasing throughput. The containers made by the method have less absorbed oxygen, thereby reducing undesirable degradation of the container's contents. The method requires minimal modification to conventional equipment, and requires little if any additional training to operate compared to conventional methods.

The invention has been described in several embodiments. It should be apparent to those skilled in the art that the invention is not limited to these embodiments, but is capable of being varied and modified without departing from the scope of the invention as set out in the attached claims.

1. A method for making a molded container from a plastic resin stored at ambient conditions, comprising the steps of: A) reducing the absorbed oxygen in the plastic resin by contacting the resin with an oxygen-depleted atmosphere; B) heating the plastic resin to a temperature at which the plastic resin can be extruded; C) extruding a quantity of the plastic resin into a mold;
D) blowing the resin against the mold; E) pressuring and flushing the molded resin with an inert gas; F) depressuring the molded resin; and G) releasing a molded container from the mold.

2. A method for making a molded container as recited in claim 1, wherein the contacting step (A) occurs at a temperature between about 120° C. and about 170° C.

3. A method for making a molded container as recited in claim 1, wherein the contacting step (A) occurs in an atmosphere substantially devoid of oxygen.

4. A method for making a molded container as recited in claim 1, wherein the mold is maintained at a temperature between about 50° F. and about 150° F., and the pressuring/flushing gas is at a temperature below about 0° F.

5. A method for making a molded container as recited in claim 1, wherein the blowing step (D) is performed using the inert gas at or near ambient temperature.

6. A molded container made using the method of claim 1, claim 2, claim 3, claim 4, claim 5, or claim 6.

7. A method for making a molded container from a plastic resin stored at ambient conditions, comprising the steps of: A) drying the plastic resin in an oxygen-depleted atmosphere; B) heating the dried plastic resin to a temperature at which the plastic resin can be extruded; C) extruding a quantity of the plastic resin into a mold; D) blowing the resin against the mold; E) pressuring and flushing the molded resin with an inert gas; F) depressuring the molded resin; and G) releasing a molded container from the mold.
